(19) United States
(12) Patent Application Publication
(10) Pub. No.: US 2002/0080121 A1
(43) Pub. Date: Jun. 27, 2002

(54) Optical mouse

(75) Inventor: Sang Eun Son, Kyungki-Do (KR)

Correspondence Address: LADAS & PARRY, 26 WEST 61ST STREET, NEW YORK, NY, 10023, US

(73) Assignee: SAMSUNG ELECTRO-MECHANICS CO.,LTD

(21) Appl. No.: 09/850,577

(22) Filed: May 7, 2001

(30) Foreign Application Priority Data
Dec. 21, 2000 (KR) P2000-79462

(51) Int. Cl. G09G 5/08

(52) U.S. Cl. 345/166

(57) ABSTRACT

Disclosed is an optical mouse based on two light-receiving lenses which include an optical sensor array for sensing light, an optical device for condensing light on the optical sensor array, and a mechanical structure. The optical mouse which includes a light source for emitting light, an irradiating lens for irradiating the light emitted from the light source to a surface, a first light-receiving lens for allowing the light emitted from the light source and irradiated through the irradiating lens to be located on a path where irregularly reflected light in the light reflected upon the surface advances, and condensing the irregularly reflected light, a second light-receiving lens for allowing the light emitted from the light source and irradiated through the irradiating lens to be located on a path where light transmitted a transparent material such as a glass and irregularly reflected upon the surface advances, and condensing the irregularly reflected light, and an optical sensor for sensing the light condensed through the first and second light-receiving lenses.

### BACKGROUND OF THE INVENTION

1. Field of the Invention

The present invention relates to an optical mouse based on two light-receiving lenses, and more particularly to, an optical mouse based on two light-receiving lens which include an optical sensor array for sensing light, an optical device for condensing light on the optical sensor array, and a mechanical structure.

2. Description of the Prior Art

Generally, a mechanically moving portion, for example, a ball mouse having a ball has problems in that sliding occurs due to dust and a user's movement may not be exactly transferred to a display screen of a computer system when the user moves the ball mouse. Also, a problem arises in that it is difficult to use the ball mouse for a long time due to abrasion of the ball and parts in contact with the ball.

To solve such problems, there has been suggested an optical mouse. The optical mouse includes a sensor array consisting of a plurality of optical sensors, optical parts for condensing light reflected upon the optical sensors, and mechanical structures.

FIG. 1 shows a relationship between a surface and a sensor array. Referring to FIG. 1, light emitted from a light source such as a light-emitting diode (LED) is reflected upon the surface, and cells of optical sensors of the sensor array sense the reflected light.

FIG. 2 shows tracking by comparison of bitmaps. Referring to FIG. 2, a sensor array consisting of a plurality of optical sensors compares bitmaps generated by sensing light, so that movement and direction of devices are provided by movement of a cursor of a computer system.

At this time, the generated bitmaps are constituted by a binary form(1 or 0).

FIG. 3 shows a configuration of a related art optical mouse.

Referring to FIG. 3, a reference numeral 11 denotes a button pressed by a user, a reference numeral 12 denotes a switch turned on/off depending on the operation of the button 11, and a reference numeral 13 denotes a circuit board that supports the switch 12.

Also, a reference numeral 14 denotes a light source that emits light, a reference numeral 15 denotes a lens for condensing light, and a reference numeral 16 denotes a housing that supports the overall structure. A reference numeral 17 denotes a lens integrated circuit (IC) that includes a sensor array, a logic circuit, and an inverter. A reference numeral 18 denotes a surface and a reference numeral 19 denotes an optical guide that guides light from the surface 18 to the lens IC 17.

The operation of the aforementioned optical mouse will briefly be described with reference to FIGS. 3 and 4. Light emitted from the light source 14 and reflected upon the surface 18 is condensed by the lens 15 and transferred to cells of the optical sensor of the lens IC 17, so that the optical sensor array converts moving optical images sensed by light to circuit signals. Thus, the converted circuit signals are transferred to a computer system to be displayed on a display screen by moving a cursor.

That is, since most of the emitted light is reflected upon a general surface, sufficient light to be sensed by the sensor is obtained. Accordingly, no problem arises in that the optical mouse is operated.

However, the optical mouse, as shown in FIG. 5, has a surface far away from a glass by a thickness of the glass in transferring the light to the sensor. In this case, light of 90% or greater is transmitted on the glass to cause the amount of the reflected light to be lack, thereby resulting in that the sensor fails to sense the light. For this reason, a problem arises in that the sensor does not function as a control device.

In other words, the aforementioned optical mouse is based on light irregularly reflected upon the surface. As shown in FIG. 5, light which has not passed through a transparent medium such as a glass is absolutely lack of the amount of irregularly reflected light. After all, the aforementioned related art optical mouse has several problems. The optical sensor fails to sense images on the glass so as not to move a cursor of a display screen of the computer system. This is because that the light-receiving lens and the sensor are set at a particular point in an irregularly reflected light path on the surface under the circumstances that there is no transparent medium, at the time of design of the optical mouse, so as not to allow the reflected light which has transmitted the transparent medium to advance to the light-receiving lens and the sensor.

### SUMMARY OF THE INVENTION

It is, therefore, an object of the present invention to provide an optical mouse based on two light-receiving lenses of which one can condense light emitted from a light source and reflected upon a surface on a sensor array and the other can move a cursor on a display screen of a computer system by allowing an optical sensor to sense light on a transparent material such as a glass using another sensor array and another lens that can sense light transmitted the transparent material such as a glass and reflected upon the surface.

To achieve the above object, there is provided an optical mouse which includes a light source for emitting light, an irradiating lens for irradiating the light emitted from the light source to a surface, a first light-receiving lens for allowing the light emitted from the light source and irradiated through the irradiating lens to be located on a path where irregularly reflected light in the light reflected upon the surface advances, and condensing the irregularly reflected light, a second light-receiving lens for allowing the light emitted from the light source and irradiated through the irradiating lens to be located on a path where light transmitted a transparent material such as a glass and irregularly reflected upon the surface advances, and condensing the irregularly reflected light, and an optical sensor for sensing the light condensed through the first and second light-receiving lenses.

The optical mouse according to the present invention is characterized in that the first and second light-receiving lenses have different refractive indexes.

The optical mouse according to the present invention is also characterized in that the first and second light-receiving lenses have the same refractive index and the second light-receiving lens is located to be lower than the first light-receiving lens.

The optical mouse according to the present invention is also characterized in that the first and second light-receiving lenses are constituted by a multi-focused lens.

The optical mouse according to the present invention is also characterized in that the irradiating lens, the first light-receiving lens, and the second light-receiving lens are formed in an integral form with one another.

### BRIEF DESCRIPTION OF THE DRAWINGS

The above objects, features and advantages of the present invention will become more apparent from the following detailed description when taken in conjunction with the accompanying drawings, in which:

FIG. 1 shows a relationship between a surface and a sensor array;

FIG. 2 shows tracking by comparison of bitmaps;

FIG. 3 shows a configuration of a related art optical mouse;

FIG. 4 shows the operation on a general surface of the related art optical mouse;

FIG. 5 shows the operation on a glass of the related art optical mouse;

FIG. 6 shows a configuration of an optical mouse according to the present invention;

FIG. 7 shows the operation on a general surface of the optical mouse according to the present invention;

FIG. 8 shows the operation on a glass of the optical mouse according to the present invention; and

FIG. 9 is another exemplary view of a light-receiving lens of the optical mouse according to the present invention.

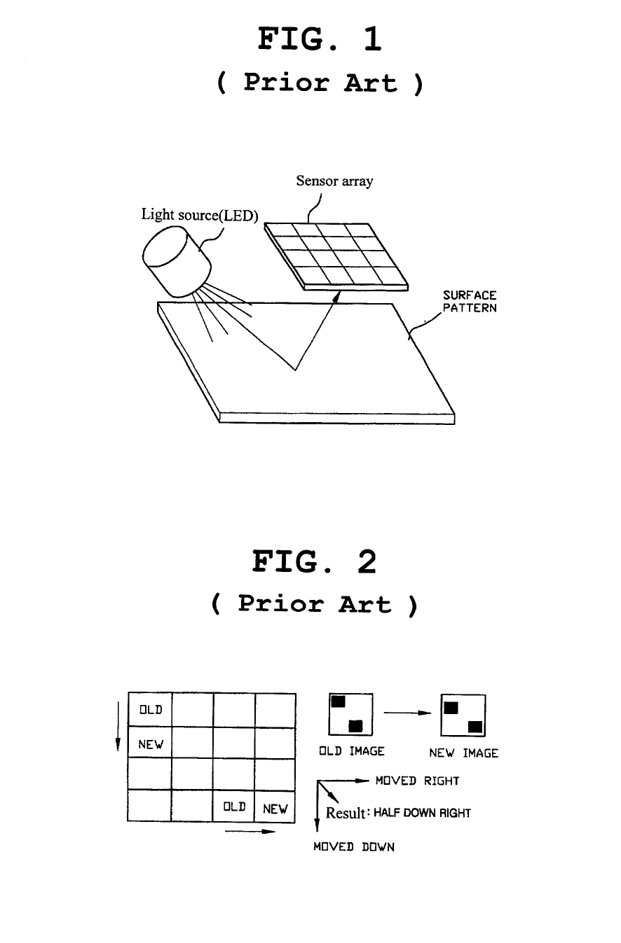

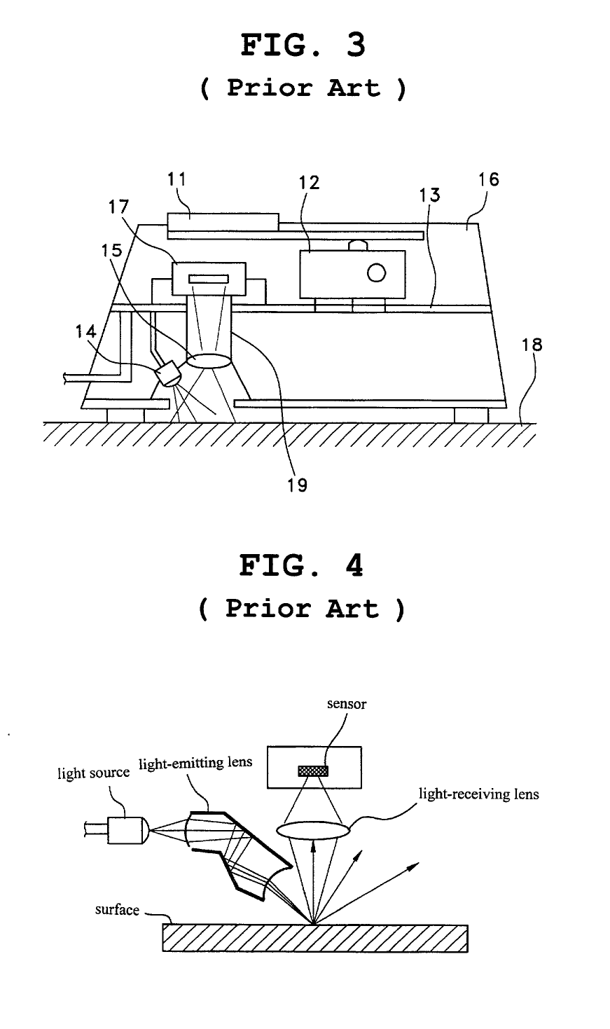

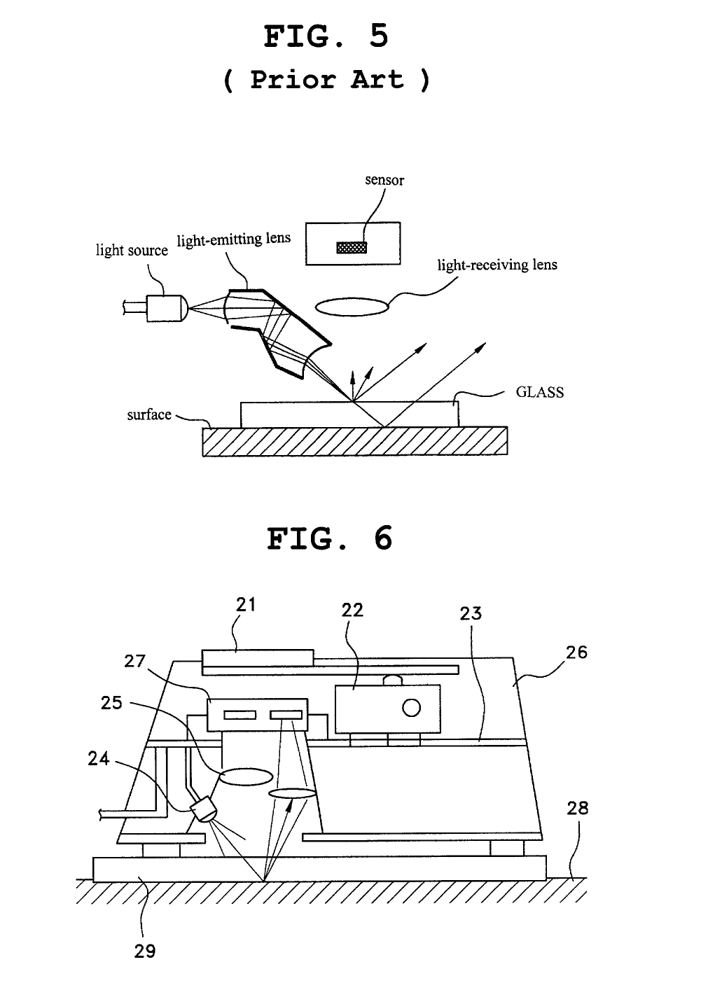

### DETAILED DESCRIPTION OF THE PREFERRED EMBODIMENT

A preferred embodiment of the present invention will now be described with reference to the accompanying drawings. In the following description, same drawing reference numerals are used for the same elements even in different drawings. The matters defined in the description such as a detailed construction and elements of a circuit are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

FIG. 6 shows a configuration of an optical mouse according to the present invention.

Referring to FIG. 6, a reference numeral 21 denotes a button pressed by a user, a reference numeral 22 denotes a switch turned on/off depending on the operation of the button 21, and a reference numeral 23 denotes a circuit board that supports the switch 22.

Also, a reference numeral 24 denotes a light source that emits light, a reference numeral 25 denotes two light-receiving lenses for condensing light, and a reference numeral 26 denotes a housing that supports the overall structure. A reference numeral 27 denotes a lens integrated circuit (IC) that includes a sensor array, a logic circuit, and an inverter. A reference numeral 28 denotes a surface and a reference numeral 29 denotes a glass.

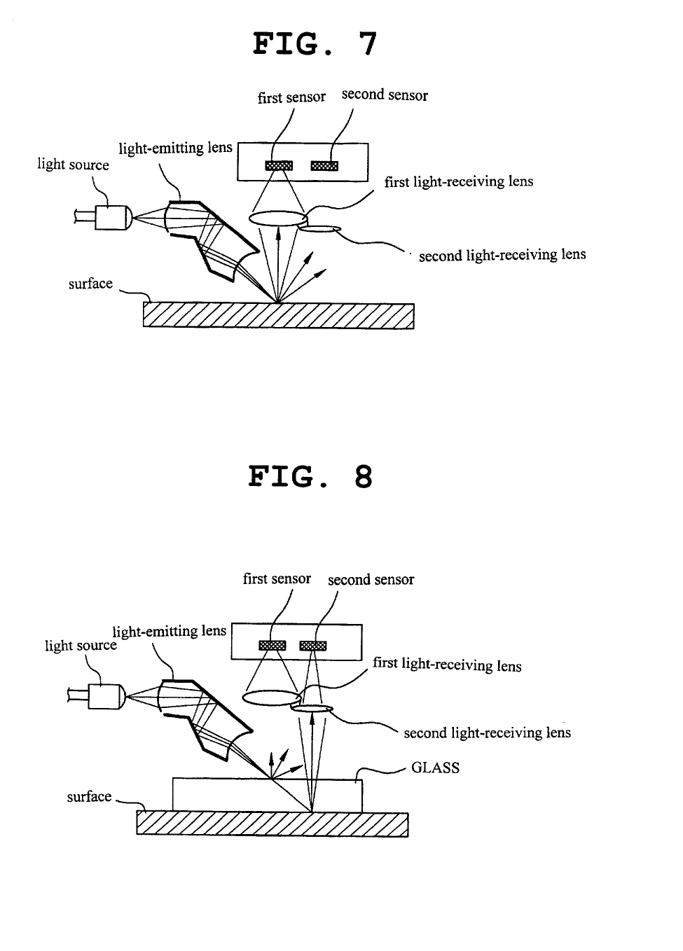

The operation of the aforementioned optical mouse on a general surface will be described with reference to FIG. 7.

Light emitted from the light source and reflected upon the surface is condensed on a first optical sensor by the first light-receiving lens so that the optical mouse performs its function.

The operation of the aforementioned optical mouse on a glass will be described with reference to FIG. 8.

When the optical mouse is on the glass, the light emitted from the light source transmits the glass and is reflected upon the surface. A light path advances toward the second light-receiving lens by totally reflecting the light reflected upon the surface. Thus, the light that passed through the second light-receiving lens is condensed on a second optical sensor so that the second optical sensor senses the light to allow the optical mouse to operate on the glass as well as the general surface. This moves a cursor on a display screen of a computer system.

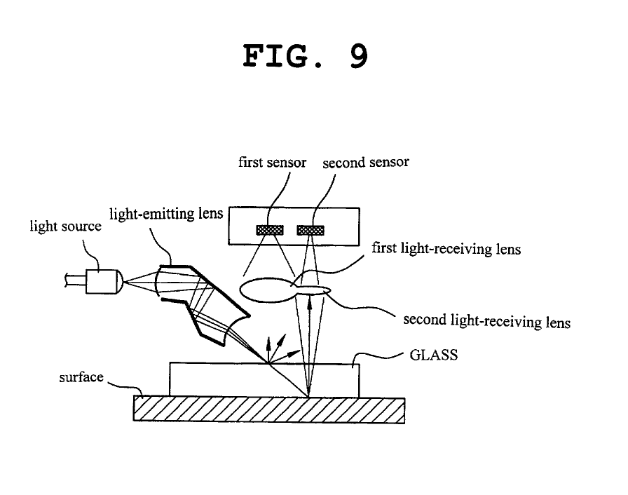

In the embodiment of FIG. 8, lenses having different refractive indexes have been respectively provided. However, one lens may be provided with different refractive indexes on the basis of a given boundary region, so that a portion for condensing light reflected upon the general surface and a portion for condensing light which transmitted a transparent medium can be formed respectively, as shown in FIG. 9. At this time, the light-emitting lens, the first light-receiving lens, and the second light-receiving lens may be formed in an integral form with one another.

The first and second light-receiving lenses can be constituted by a multi-focused lens.

Referring to FIGS. 7 to 9, the light source and the light-emitting lens are denoted by one reference numeral 24 of FIG. 6.

As aforementioned, the optical mouse based on two light-receiving lens has the following advantage.

It is possible to move the cursor on the display screen of the computer system by allowing the optical sensor to sense light on the transparent material such as a glass using another sensor array and another lens that can sense light transmitted the transparent material and reflected upon the surface.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An optical mouse comprising:
a light source for emitting light;
a first light-receiving lens for allowing the light emitted from the light source and irradiated through the irradiating lens to be located on a path where irregularly reflected light in the light reflected upon a surface advances, and condensing the irregularly reflected light;
a second light-receiving lens for allowing the light emitted from the light source and irradiated through the irradiating lens to be located on a path where light transmitted a transparent material such as a glass and irregularly reflected upon the surface advances, and condensing the irregularly reflected light; and
an optical sensor for sensing the light condensed through the first and second light-receiving lenses.

2. The optical mouse of claim 1, further comprising an irradiating lens for irradiating the light emitted from the light source to the surface.

3. The optical mouse of claim 1, wherein the first and second light-receiving lenses have different refractive indexes.

4. The optical mouse of claim 1, wherein the first and second light-receiving lenses have the same refractive index and the second light-receiving lens is located to be lower than the first light-receiving lens.

5. The optical mouse of claim 1, wherein the first and second light-receiving lenses are constituted by a multi-focused lens.

6. The optical mouse of claim 2, wherein the irradiating lens, the first light-receiving lens, and the second light-receiving lens are formed in an integral form with one another.
